(19) United States
(12) Patent Application Publication
(10) Pub. No.: US 2025/0082022 A1
(43) Pub. Date: Mar. 13, 2025

(54) AEROSOL GENERATING DEVICE

(71) Applicant: KT&G CORPORATION, Daejeon (KR)

(72) Inventors: Jong Sub LEE, Gyeonggi-do (KR); Dae Nam HAN, Seoul (KR); Sun Hwan JUNG, Daejeon (KR); Byung Sung CHO, Gyeonggi-do (KR)

(73) Assignee: KT&G CORPORATION, Daejeon (KR)

(21) Appl. No.: 18/290,518

(22) PCT Filed: Aug. 1, 2023
(86) PCT No.: PCT/KR2023/011212

§ 371 Date: Nov. 14, 2023

(30) Foreign Application Priority Data
Aug. 18, 2022 (KR) 10-2022-0103494
Oct. 5, 2022 (KR) 10-2022-0127176

(51) Int. Cl. A24F 40/44; A24F 40/10; A24F 40/42; A24F 40/46; A24F 40/48; H05B 3/16

(52) U.S. Cl. CPC A24F 40/44; A24F 40/10; A24F 40/42; A24F 40/46; A24F 40/48; H05B 3/16; H05B 2203/013; H05B 2203/017; H05B 2203/021

(57) ABSTRACT

An aerosol generating device may include: a cartridge including a reservoir for storing an aerosol generating material; a heater assembly detachably coupled to the cartridge and configured to heat the aerosol generating material provided from the cartridge to generate an aerosol; and a body detachably coupled to the heater assembly and including a battery configured to supply power to the heater assembly, wherein the heater assembly may include: a chamber in fluid communication with the reservoir of the cartridge; a wick configured to absorb the aerosol generating material supplied from the reservoir; and a heater arranged in at least a region of a side surface of the wick and configured to heat the aerosol generating material absorbed into the wick.

### TECHNICAL FIELD

One or more embodiments relate to an aerosol generating device capable of preventing accumulation of a liquefied aerosol in an aerosol generating chamber.

### BACKGROUND ART

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes.

Particularly, compared with an aerosol generating device in which an aerosol generating material in a solid state is used, an aerosol generating device using an aerosol generating material in a liquid state has a smaller size and thus is more convenient to carry. Also, as no smoking byproduct is generated, it is more convenient to use. Therefore, there is an increasing interest in an aerosol generating device configured to generate an aerosol using an aerosol generating material in a liquid state.

### DISCLOSURE OF INVENTION

### Technical Problem

In an aerosol generating device in which an aerosol generating material in a liquid state is used, vapors generated by heating the aerosol generating material of liquid state and air may be mixed in a chamber in which an aerosol is generated (or ‘an aerosol generating chamber’), and thus, the aerosol may be generated.

At least some of the aerosol generated in the chamber may be cooled and liquefied by contact with air, and as a result, the liquefied aerosol may be accumulated in the chamber.

When the liquefied aerosol is accumulated in the chamber, leakage may occur and cause malfunction or damage of components of the aerosol generating device. In addition, when the liquefied aerosol is accumulated in the chamber, a portion of a heater in the chamber may be submerged under the liquefied aerosol and heating efficiency of the heater may be degraded. As a result, a generation amount of the aerosol may decrease.

The present disclosure provides an aerosol generating device by which accumulation of a liquefied aerosol in a chamber in which an aerosol is generated may be prevented, to thereby prevent malfunction and damage of components of the aerosol generating device due to leakage and prevent the heater from being submerged under the liquefied aerosol.

The technical problems of the present disclosure are not limited to the above-described description, and other technical problems may be clearly understood by one of ordinary skill in the art from the embodiments to be described hereinafter.

### Solution to Problem

According to an embodiment, an aerosol generating device may include: a cartridge including a reservoir in which an aerosol generating material is stored; a heater assembly detachably coupled to the cartridge and configured to heat the aerosol generating material provided from the cartridge to generate an aerosol; and a body detachably coupled to the heater assembly and including a battery configured to supply power to the heater assembly, wherein the heater assembly includes: a chamber in fluid communication with the reservoir of the cartridge; a wick arranged in the chamber, configured to absorb the aerosol generating material supplied from the reservoir, and including a first surface facing the reservoir, a second surface arranged in an opposite position of the first surface to face a bottom surface of the chamber, and a side surface surrounding a space between the first surface and the second surface; and a heater arranged on the side surface of the wick and configured to heat the aerosol generating material absorbed into the wick.

According to another embodiment, an aerosol generating device may include: a cartridge including a reservoir in which an aerosol generating material is stored; a heater assembly detachably coupled to the cartridge and configured to heat the aerosol generating material provided from the cartridge to generate an aerosol; and a body detachably coupled to the heater assembly and including a battery configured to supply power to the heater assembly, wherein the heater assembly includes: a chamber in fluid communication with the reservoir of the cartridge; a wick arranged in the chamber, configured to absorb the aerosol generating material supplied from the reservoir, and including a first surface facing the reservoir, a second surface arranged in an opposite position of the first surface to face a bottom surface of the chamber, and a side surface surrounding a space between the first surface and the second surface; and a heater arranged on the first surface of the wick and configured to heat the aerosol generating material absorbed into the wick, and the first surface absorb of the wick may absorb the aerosol liquefied in the chamber.

According to another embodiment, an aerosol generating device may include: a cartridge including a reservoir in which an aerosol generating material is stored; a heater assembly detachably coupled to the cartridge and configured to heat the aerosol generating material provided from the cartridge to generate the aerosol; and a body detachably coupled to the heater assembly and including a battery configured to supply power to the heater assembly, wherein the heater assembly includes: a chamber in fluid communication with the reservoir of the cartridge; a wick arranged in the chamber, configured to absorb the aerosol generating material provided from the reservoir, and including a through hole extending in a longitudinal direction of the chamber; and a heater arranged in the through hole of the wick and configured to heat the aerosol generating material absorbed into the wick. At least a region of the wick may absorb the aerosol liquefied in the through hole.

### Advantageous Effects of Invention

An aerosol generating device according to various embodiments of the present disclosure may prevent accumulation of a liquefied aerosol in a chamber in which an aerosol is generated.

In addition, the aerosol generating device according to various embodiments of the present disclosure may prevent occurrence of leakage due to the liquefied aerosol, to thereby prevent malfunction and breakdown of components of the aerosol generating device.

In addition, the aerosol generating device according to various embodiments of the present disclosure may prevent the heater in the chamber from being submerged under the liquefied aerosol, to thereby prevent decrease in a generation amount of the aerosol due to the liquefied aerosol.

Effects of the present disclosure are not limited to the above effects, and effects that are not mentioned could be clearly understood by one of ordinary skill in the art from the present specification and the attached drawings.

### BRIEF DESCRIPTION OF DRAWINGS

FIG. 1 is a perspective view of an aerosol generating device according to an embodiment;

FIG. 2 is an exploded view of the aerosol generating device shown in FIG. 1;

FIG. 3 is a perspective view of a heater assembly of an aerosol generating device according to an embodiment;

FIG. 4 is a perspective view of a cross-section of the heater assembly shown in FIG. 3, taken in A-A′ direction, according to an embodiment;

FIG. 5 is a cross-sectional view of the heater assembly shown in FIG. 3, taken in BB′ direction, according to an embodiment;

FIG. 6 is a diagram of a process in which an aerosol liquefied in a chamber of the aerosol generating device according to an embodiment is absorbed into a wick;

FIG. 7 is a perspective view of a cross-section of the heater assembly shown in FIG. 3, taken in the A-A′ direction, according to another embodiment;

FIG. 8 is a cross-sectional view of the heater assembly shown in FIG. 7;

FIG. 9 is a perspective view of a cross-section of the heater assembly shown in FIG. 3, taken in the A-A′ direction, according to another embodiment;

FIG. 10 is a cross-sectional view of the heater assembly shown in FIG. 9; and

FIG. 11 is a block diagram of an aerosol generating device according to an embodiment.

### MODE FOR THE INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, hen an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated from the vibrator, and the heat and/or ultrasonic vibrations generated from the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the susceptor may be a magnetic body that generates heat by an external magnetic field. As the susceptor is positioned inside the coil and a magnetic field is applied to the susceptor, the susceptor generates heat to heat an aerosol generating article. In addition, optionally, the susceptor may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

Hereinafter, embodiments of the present disclosure will be described in detail with reference to the drawings.

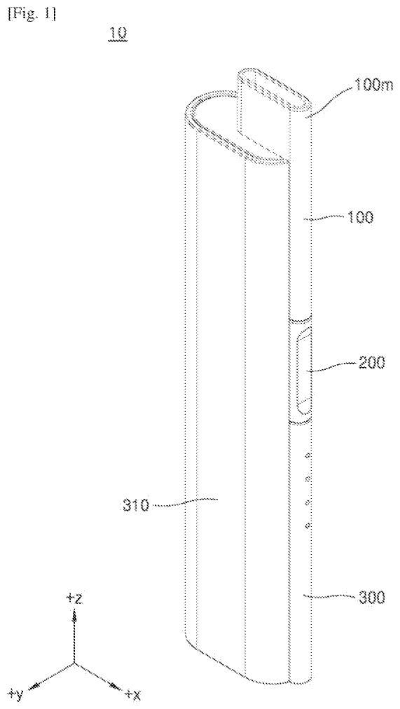

FIG. 1 is a perspective view of an aerosol generating device according to an embodiment.

Referring to FIG. 1, an aerosol generating device 10 according to an embodiment may include a cartridge 100, a heater assembly 200, and a body 300.

An aerosol generating material may be stored in the cartridge 100, and the aerosol generating material stored in the cartridge 100 may be supplied to the heater assembly 200 arranged at a bottom of the cartridge 100 (e.g., an end portion in the −z direction shown in FIG. 1).

The heater assembly 200 may be between the cartridge 100 and the body 300, and may be configured to perform a function of generating an aerosol by changing a phase of the aerosol-generating material into a gas phase. The aerosol may be generated by heating the aerosol generating material supplied from the cartridge 100.

For example, the heater assembly 200 may generate vapor from the aerosol-generating material by heating the aerosol generating material supplied from the cartridge 100, and the vapor that has been generated may be mixed with external air introduced from an outer portion of the heater assembly 200 into the heater assembly 200 to generate the aerosol. In the present disclosure, “aerosol” may indicate particles generated by combination of vapor and air, in which the vapor is generated by heating an aerosol generating material, and the expression may be used as a same meaning hereinafter.

According to an embodiment, the cartridge 100 may include a mouthpiece 100m configured to supply the aerosol to a user. For example, the mouthpiece 100m may provide connection or fluid communication between the inside of the heater assembly 200 and the outside of the aerosol generating device 10, and the aerosol generated in the heater assembly 200 may be discharged to the outside of the aerosol generating device 10 through the mouthpiece 100m. Here, the user may put the mouthpiece 100m in his/her mouth and inhale the aerosol discharged to the outside of the aerosol generating device 10.

The body 300 may support the heater assembly 200 at a bottom of the heater assembly 200, and components for operation of the aerosol generating device 10 may be arranged in the body 300. For example, a battery (not shown) and a processor (not shown) may be arranged in the body 300. However, the battery and the processor are only examples of components arranged in the body 300, and in addition to the aforementioned components, other components (e.g., a user interface, a sensor, and the like) may be further arranged in the body 300.

According to an embodiment, the aerosol generating device 10 may further include a cover 310 for protecting the components of the aerosol generating device 10.

The cover 310 may be arranged to surround at least a region of each of the cartridge 100, the heater assembly 200, and the body 300, may fix positions of the cartridge 100, the heater assembly 200, and the body 300, and may protect the cartridge 100, the heater assembly 200, and the body 300 from external impacts or introduction of foreign materials.

According to an embodiment, the cover 310 may be integrally formed with the body 300, but is not limited thereto. In another embodiment, the cover 310 may be detachably coupled to the body 300.

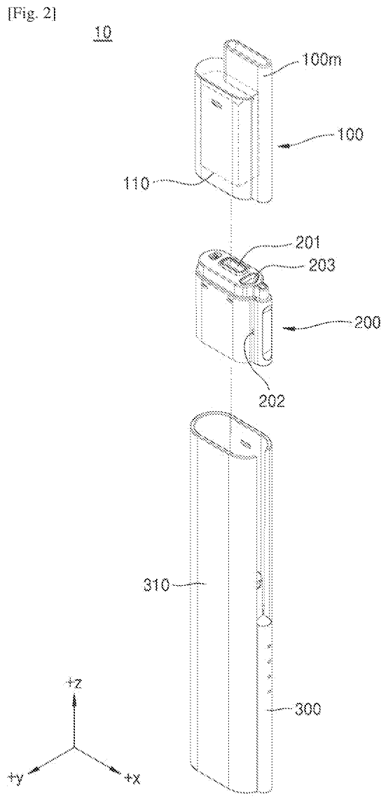

Hereinafter, a combination relationship among the cartridge 100, the heater assembly 200, and the body 300 will be described in detail with reference to FIG. 2.

FIG. 2 is an exploded view of the aerosol generating device shown in FIG. 1.

Referring to FIG. 2, the aerosol generating device 10 according to an embodiment may include the cartridge 100, the heater assembly 200, the body 300, and the cover 310. At least one of components of the aerosol generating device 10 may be identical or similar to at least one of the components of the aerosol generating device 10 shown in FIG. 1, and hereinafter, descriptions thereof will not be repeatedly given.

In addition, the components of the aerosol generating device 10 are not limited to the description, and according to embodiments, at least one (e.g., a cover 310) from among the aforementioned components may be omitted, or other components may be added.

The cartridge 100 may include a reservoir 110, in which the aerosol generating material is stored, and a mouthpiece 100m (e.g., the mouthpiece 100m shown in FIG. 1) configured to provide an aerosol generated in the heater assembly 200 to the user.

When the cartridge 100 and the heater assembly 200 are coupled to each other, the reservoir 110 may be in connection or fluid communication with an inner space of the heater assembly 200, and as a result, the aerosol generating material stored in the reservoir 110 may be introduced into the inner space of the heater assembly 200.

Here, the aerosol generating material stored in the reservoir 110 may include a tobacco-containing material including a volatile tobacco-flavor component or a liquid composition including a non-tobacco material.

According to an embodiment, the liquid composition may include any one ingredient from among water, a solvent, ethanol, plant extract, spices, flavorings, and a vitamin mixture, or a mixture of the aforementioned ingredients. The spices may include menthol, peppermint, spearmint oil, and various fruit-flavored ingredients, but are not limited thereto. The flavorings may include ingredients capable of providing various flavors or tastes to a user. Vitamin mixtures may include a mixture of at least one of vitamin A, vitamin B, vitamin C, and vitamin E, but are not limited thereto. In addition, the liquid composition may include an aerosol forming agent, such as glycerin and propylene glycol.

For example, the liquid composition may include any weight ratio of glycerin and propylene glycol solution to which nicotine salts are added. The liquid composition may include two or more types of nicotine salts. The nicotine salt may be formed by adding suitable acids, including organic acids or inorganic acids, to nicotine. Nicotine may include a naturally generated nicotine or synthetic nicotine, and may have any suitable weight concentration relative to a total solution weight of the liquid composition.

The acid for forming the nicotine salt may be appropriately selected in consideration of a nicotine absorption rate in the blood, an operation temperature of the aerosol generating device 10, flavors or savors, solubility, and the like. For example, the acid for forming the nicotine acid may include a single acid selected from among a group including benzoic acid, lactic acid, salicylic acid, lauric acid, sorbic acid, levulic acid, pyruvic acid, formic acid, acetic acid, propionic acid, butyric acid, valeric acid, caproic acid, caprylic acid, capric acid, citric acid, myristic acid, palmitic acid, stearic acid, oleic acid, linoleic acid, linolenic acid, phenylacetic acid, tartaric acid, succinic acid, fumaric acid, gluconic acid, saccharic acid, malonic acid or malic acid, or a mixture of two or more acids selected from the group, but is not limited thereto.

The heater assembly 200 may be detachably coupled to a bottom surface of the cartridge 100 (e.g., the surface facing the −z direction shown in FIG. 2), and may generate the aerosol by heating the aerosol generating material supplied from the reservoir 110 of the cartridge 100.

For example, as a first combination member (not shown) arranged in a region of the heater assembly 200 facing the cartridge 100 is coupled to or separated from a second combination member (not shown) arranged on the bottom surface of the cartridge 100, the heater assembly 200 may be detachably coupled to the cartridge 100. However, a method in which the cartridge 100 and the heater assembly 200 are coupled to each other is not limited thereto.

For example, the heater assembly 200 may include an aerosol generating material inlet 201 connecting the inside of the heater assembly 200 and the inside of the reservoir 110 of the cartridge 100, an air inlet 202 through which external air is introduced into the heater assembly 200, and an air outlet 203 through which the aerosol generated in the heater assembly 200 is discharged to the outside of the heater assembly 200.

The aerosol generating material stored in the reservoir 110 of the cartridge 100 may be introduced to the inside of the heater assembly 200 through the aerosol generating material inlet 201, and the heater (not shown) arranged in the heater assembly 200 may heat the aerosol generating material supplied from the reservoir 110. The external air may be introduced into the heater assembly 200 through the air inlet 202. In the heater assembly 200, the external air introduced into the heater assembly 200 and the vapor generated by heating the aerosol generating material may be mixed, and thus, the aerosol may be generated.

The aerosol generated in the heater assembly 200 may be introduced from the heater assembly 200 to the cartridge 100 through the air outlet 203 arranged in the region of the heater assembly 200 facing the cartridge 100, and then may be discharged to the outside of the aerosol generating device 10 through the mouthpiece 100m. For example, as a puff of the user through the mouthpiece 100m causes decrease in a pressure of the inside of the cartridge 100, the air and/or the aerosol in the heater assembly 200 moves from the heater assembly 200 to the inside of the cartridge 100, and the user may inhale the air and/or aerosol that has moved to the inside of the cartridge 100.

The body 300 may be detachably coupled to a bottom surface (e.g., a surface facing the −z direction shown in FIG. 2) of the heater assembly 200 to support the heater assembly 200. For example, the body 300 may be detachably connected to the heater assembly 200 in a scheme where at least a region of the body 300 is inserted into an insertion groove (not shown) formed on the bottom surface of the heater assembly 200 or separated from the insertion groove. However, a scheme of combination of the heater assembly 200 and the body 300 is not limited thereto.

According to an embodiment, components for operation of the aerosol generating device 10 may be arranged in the body 300. For example, a battery (not shown) for power supply and a processor (not shown) configured to control operations of the aerosol generating device 10 may be arranged in the body 300.

The battery may supply power to be used for the aerosol generating device 10 to operate. For example, the battery may be electrically connected to the heater assembly 200 and may supply power for the heater of the heater assembly 200 to be heated. As another embodiment, the battery may also supply power for other components (e.g., the processor) of the aerosol generating device 10 to operate.

The processor may generally control operations of the aerosol generating device 10. The processor may be implemented as an array of a plurality of logic gates or may be implemented as a combination of a general-purpose microprocessor and a memory in which a program executable in the microprocessor is stored, but the processor is not limited thereto.

According to an embodiment, the processor may control power supplied from the battery to the heater of the heater assembly 200. For example, the processor may control an amount of power supplied from the battery to the heater and a time period during which the power is supplied, such that the heater of the heater assembly 200 may be heated to a certain temperature or may maintain a preset temperature.

The aerosol generating device 10 according to an embodiment may enable replacement of the cartridge 100 and/or the heater assembly 200 through a structure in which the cartridge 100 and the heater assembly 200 are detachably coupled to each other and the heater assembly 200 and the body 300 are detachably coupled to each other.

For example, when the aerosol generating material stored in the reservoir 110 of the cartridge 100 is exhausted, the user may replace the cartridge 100 to continue smoking. As another example, when performances of the components (e.g., the heater or the wick) of the heater assembly 200 are degraded and thus may not generate a sufficient amount of aerosol, the user may replace the heater assembly 200 such that a sufficient amount of aerosol is generated.

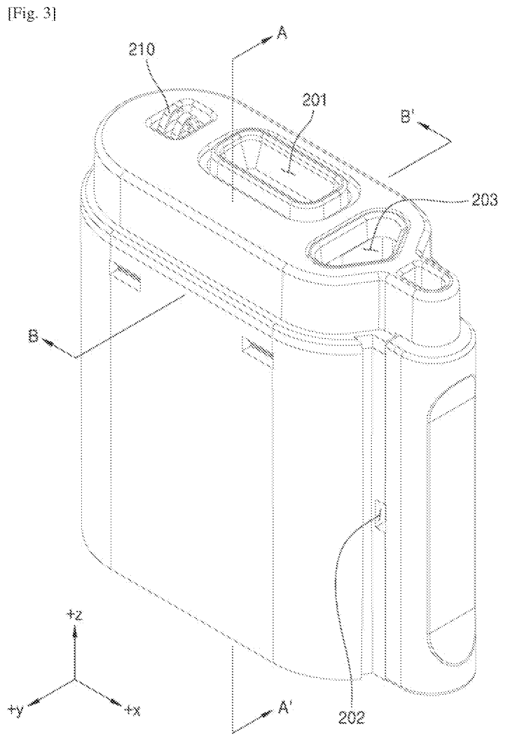

Hereinafter, the components of the heater assembly 200 will be described in detail with reference to FIGS. 3 to 5.

FIG. 3 is a perspective view of the heater assembly of the aerosol generating device according to an embodiment; The heater assembly 200 shown in FIG. 3 may correspond to an embodiment of the heater assembly 200 of the aerosol generating device 10 shown in FIGS. 1 to 2, and hereinafter, descriptions thereof will not be repeatedly given.

Referring to FIG. 3, the heater assembly 200 according to an embodiment may include the aerosol generating material inlet 201, the air inlet 202, and the air outlet 203.

The aerosol generating material inlet 201 may be configured to introduce the aerosol generating material from a cartridge (e.g., the cartridge 100 shown in FIG. 1 or 2) into the heater assembly 200. For example, the aerosol generating material inlet 201 may be arranged in a region of the heater assembly 200 coupled to the cartridge, and the aerosol generating material stored in a reservoir of the cartridge may be introduced into the heater assembly 200 through the aerosol generating material inlet 201.

The air inlet 202 may introduce air outside the heater assembly 200 (hereinafter, referred to as ‘external air’) into the heater assembly 200. For example, the air inlet 202 may be arranged in another region of the heater assembly 200 (e.g., a side surface of the heater assembly 200) apart from the aerosol generating material inlet 201, and the external air may be introduced into the heater assembly 200 through the air inlet 202.

The external air introduced into the heater assembly 200 may move or flow into a chamber (not shown), in which the aerosol is generated, through an air flow path (not shown) arranged in the heater assembly 200, and details thereof will be described later.

The air outlet 203 may discharge the aerosol and/or air generated in the heater assembly 200 to the outside of the heater assembly 200 or to the cartridge. For example, the air outlet 203 may be arranged apart from the aerosol generating material inlet 201 in the region of the heater assembly 200 coupled to the cartridge, and the aerosol and/or air in the assembly 200 may be discharged to the outside of the heater assembly 200 through the air outlet 203.

The aerosol and/or air discharged to the outside of the heater assembly 200 through the air outlet 203 in a state where the cartridge and the heater assembly 200 are coupled to each other may be introduced into the cartridge, and then may be discharged to the outside of the cartridge through a mouthpiece (e.g., the mouthpiece 100m shown in FIG. 1 or 2) by a puff operation of the user.

The heater assembly 200 according to an embodiment may further include a first combination member 210 for coupling of the heater assembly 200 and the cartridge. The first combination member 210 may be arranged in the region of the heater assembly 200 coupled to the cartridge, and may be detachably coupled to a second combination member (not shown) arranged in a region (e.g., a bottom surface) of the cartridge coupled to the heater assembly 200.

In an example, as a portion of the heater assembly 200 is inserted into the cartridge, the first combination member 210 of the heater assembly 200 and the second combination member of the cartridge may be coupled to each other, and thus, a combination state of the heater assembly 200 and the cartridge may be maintained. In another example, when a force in a direction away from the heater assembly 200 is applied to the cartridge in a state where the heater assembly 200 and the cartridge are coupled to each other, the combination between the first combination member 210 and the second combination member may be released, and the cartridge may be detached from the heater assembly 200.

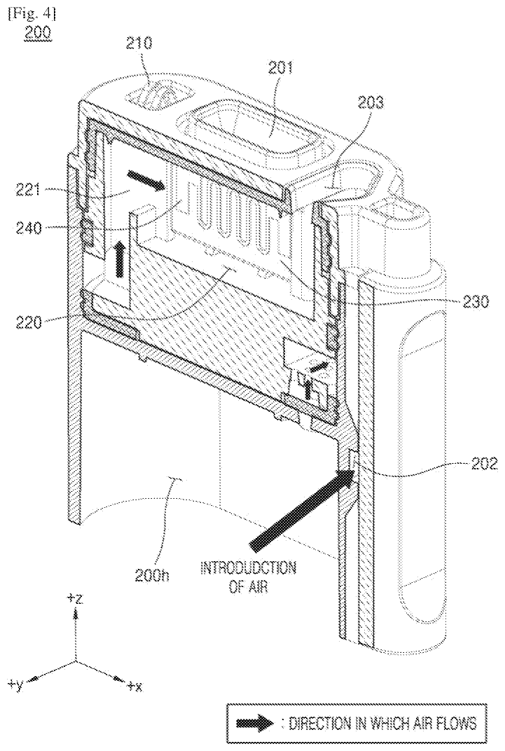

FIG. 4 is a perspective view of a cross-section of the heater assembly shown in FIG. 3, taken in A-A′ direction, according to an embodiment. In FIG. 4, the black arrows indicate a direction in which the air (or ‘the external air’) moves.

Referring to FIG. 4, the heater assembly 200 according to an embodiment may include the aerosol generating material inlet 201, the air inlet 202, the air outlet 203, the first combination member 210, a chamber 220, a wick 230, and a heater 240. At least one of the components of the heater assembly 200 according to an embodiment may be identical or similar to at least one of the components of the heater assembly 200 shown in FIG. 3, and hereinafter, descriptions thereof will not be repeatedly given.

The chamber 220 (or ‘the aerosol generating chamber’) may be formed in the inner space of the heater assembly 200, and in the chamber 220, and the aerosol generating material introduced from the reservoir of the cartridge may be heated to generate the aerosol.

According to an embodiment, the chamber 220 may be in fluid communication or fluid coupling with the reservoir of the cartridge through the aerosol generating material inlet 201, and the aerosol generating material inlet 201 stored in the reservoir of the cartridge may be introduced into the chamber 220 through the aerosol generating material inlet 201.

The wick 230 may be in a region in the chamber 220 adjacent to the aerosol generating material inlet 201, and may absorb the aerosol generating material introduced into the chamber 220 through the aerosol generating material inlet 201.

For example, at least a region of the wick 230 may be arranged to face the aerosol generating material inlet 201 and absorb the aerosol generating material inlet 201 introduced into the chamber 220 through the aerosol generating material inlet 201.

According to an embodiment, the wick 230 may include ceramic fiber or porous ceramic for absorbing the aerosol generating material. In other words, the wick 230 may include a ceramic wick. However, the wick 230 is not limited to the aforementioned embodiment, and according to embodiments, the wick 230 may also include other materials (e.g., cotton or glass).

The heater assembly 200 according to an embodiment may further include a support member 221 arranged in the chamber 220. The support member 221 may be arranged in the chamber 220 and may fix a position of the wick 230 in the chamber 220. As the wick 230 is fixed to the inside of the chamber 220 by the support member 221, even when the heater assembly 200 inclines or wavers in a process of using the aerosol generating device, the wick 230 may stably absorb the aerosol generating material.

The heater 240 may be arranged on a side (e.g., a surface facing the +y direction) of the wick 230 and heat the aerosol generating material absorbed into the wick 230. For example, the heater 240 may heat the aerosol generating material absorbed into the wick 230 using power supplied from the battery of the body (e.g., the body 300 shown in FIG. 1 or 2).

The heater 240 may include a metal material generating heat due to an electrical resistance. For example, the heater 240 may include stainless steel to avoid corrosion due to the aerosol generating material absorbed into the wick 230, but the metal material of the heater 240 is not limited thereto. In other examples, the heater 240 may include a metal material such as copper, nickel, and tungsten.

According to an embodiment, the heater 240 may include a conductive pattern printed on a side surface of the wick 230. For example, the heater 240 may be formed by the metal material (e.g., stainless steel) printed in a certain pattern on a side of the wick 230 facing the +y direction, but is not limited thereto.

According to another embodiment, the heater 240 may include an insert-injected conductive pattern on a side surface of the wick 230. For example, the heater 240 may be formed by the metal material (e.g., stainless steel) insert-injected in a certain pattern on the side of the wick 230 facing the +y direction, but the method of forming the heater 240 or the form of the heater 240 is not limited to the aforementioned embodiment.

Although not shown, according to another embodiment, the heater 240 may also include a conductive plate arranged on a side surface of the wick 230.

As the heater 240 is arranged on the side surface of the heater 240, vapor due to heating of the aerosol generating material may be generated near the side surface of the wick 230 in the chamber 220. The vapor generated from the aerosol generating material may be mixed with the air introduced into the chamber 220 through the air inlet 202.

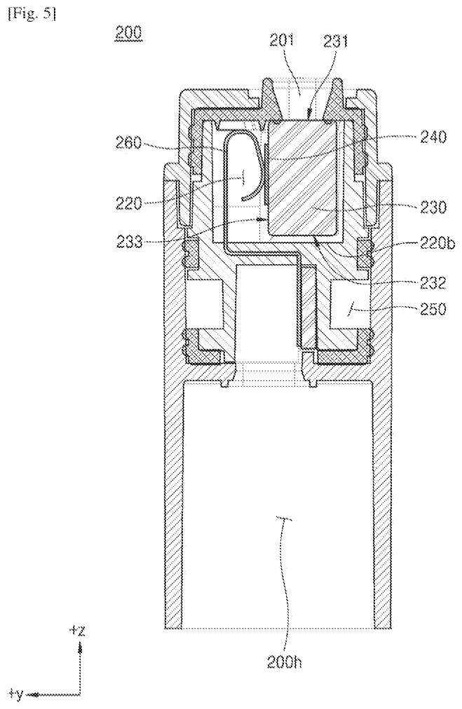

Here, the external air may be introduced into the heater assembly 200 through the air inlet 202, and may flow along the air flow path 250 (see FIG. 5) into the chamber 220. The air flow path 250 may connect the air inlet 202 and the air outlet 203 and form a flow path through which the external air and/or aerosol moves.

According to an embodiment, at least a part of the air flow path 250 may extend in the heater assembly 200 along an edge of the heater assembly 200, and the external air introduced into the heater assembly 200 through the air inlet 202 may reach the inside of the chamber 220 along the air flow path 250.

The vapor generated as the aerosol generating material is heated by the heater 240 may be mixed with the external air introduced into the chamber 220 through the air flow path 250, and as a result, the aerosol may be formed in the region of the chamber 220 adjacent to the side surface of the wick 230. The aerosol and/or external air that has been generated may be discharged to the outside of the heater assembly 200 through the air outlet 203.

According to an embodiment, the heater assembly 200 may include an insertion groove 200h into which at least a portion of the body 300 shown in FIG. 2 is inserted.

The insertion groove 200h may be formed in a region (e.g., a region facing the −z direction) of the heater assembly 200 that is coupled to the body. When the heater assembly 200 and the body are coupled to each other, the heater assembly 200 and the body may be coupled to each other as at least a portion of the body is inserted into the heater assembly 200. For example, the heater assembly 200 and the body may be coupled to each other as at least a portion of the body is coupled to the insertion groove 200h of the heater assembly 200 in a fit or an interference fit manner, but a method of combination of the heater assembly 200 and the body is not limited thereto.

FIG. 5 is a cross-sectional view of the heater assembly shown in FIG. 3, taken in BB′ direction, according to an embodiment.

Referring to FIG. 5, the heater assembly 200 according to an embodiment may include the chamber 220, the wick 230, the heater 240, the air flow path 250, and a first electrical connection member 260. The heater assembly 200 according to an embodiment may be substantially identical to or similar to the heater assembly 200 shown in FIG. 4, and hereinafter, descriptions thereof will not be repeatedly given.

The wick 230 absorbing the aerosol generating material supplied from the cartridge (e.g., the cartridge 100 shown in FIG. 1 or 2) and the heater 240 configured to generate the aerosol generating material absorbed into the wick 230 may be arranged in the chamber 220 of the heater assembly 200.

At least a region of the wick 230 may be arranged to face the aerosol generating material inlet 201 and absorb the aerosol generating material introduced into the chamber 220 through the aerosol generating material inlet 201.

According to an embodiment, the wick 230 may include a first surface 231 (or ‘a top surface’) facing the aerosol generating material inlet 201, a second surface 232 (or ‘a bottom surface’) in an opposite position of the first surface 231, and a side surface 233 surrounding a space between the first surface 231 and the second surface 232.

When the heater assembly 200 and the cartridge are coupled to each other, the first surface 231 of the wick 230 may be arranged to face the reservoir of the cartridge, and may absorb the aerosol generating material introduced from the reservoir into chamber 220 through the aerosol generating material inlet 201.

The second surface 232 of the wick 230 may be in the opposite position of the first surface 231 and arranged to face a bottom surface 220b of the chamber 220. In an embodiment, the second surface 232 of the wick 230 may be arranged apart by a certain distance from the bottom surface 220b of the chamber 220.

This is because, if the second surface 232 of the wick 230 contacts the bottom surface 220b of the chamber 220, at least a portion of the aerosol generating material absorbed into the wick 230 may leak along the bottom surface 220b of the chamber 220 into the inner space of the heater assembly 200 or to the inside of the body (e.g., the body 300 shown in FIG. 1 or 2) coupled to the heater assembly 200.

As the aerosol generating material leaks, other components of the heater assembly 200 or components of the body may malfunction or may be damaged. The heater assembly 200 according to an embodiment may prevent the aerosol generating material from leaking to the outside of the chamber by the structure in which the second surface 232 of the wick 230 and the bottom surface 220b of the chamber 220 are separated from each other.

The side surface 233 of the wick 230 may surround the space between the first surface 231 and the second surface 232, and the heater 240 may be arranged in at least a region of the side surface 233 of the wick 230.

The heater 240 may be electrically connected to a battery in the body through the first electrical connection member 260, in a state where the heater assembly 200 and the body are coupled to each other. For example, as a region of the first electrical connection member 260 contacts at least a region of the heater 240 and another region of the first electrical connection member 260 contacts at least a region of the body inserted into the insertion groove 200h, the heater 240 and the body may be electrically connected to each other. The battery in the body may supply power to the heater 240 through the aforementioned electrical connection relationship, and the heater 240 may generate heat in response to the supply of the power from the battery to heat the aerosol generating material absorbed into the wick 230.

As the heater 240 is on the side surface 233 of the wick 230, the vapor generated as the aerosol generating material is heated may be generated in a region of the chamber 220 adjacent to the side surface 233 of the wick 230. The vapor that has been generated may be mixed with external air that is introduced into the chamber 220 and flows through the air flow path 250 extending along the edge of the heater assembly 200. As a result, the aerosol may be generated in the region of the chamber 220 adjacent to the side surface 233 of the wick 230.

At least some of the aerosol generated in the chamber 220 may be cooled and liquefied due to contact with the external air introduced into the chamber 220 through the air flow path 250, and the aerosol that has been liquefied (or ‘droplet’) may fall onto the bottom surface 220b of the chamber 220 and may be accumulated or piled on the bottom surface 220b of the chamber 220.

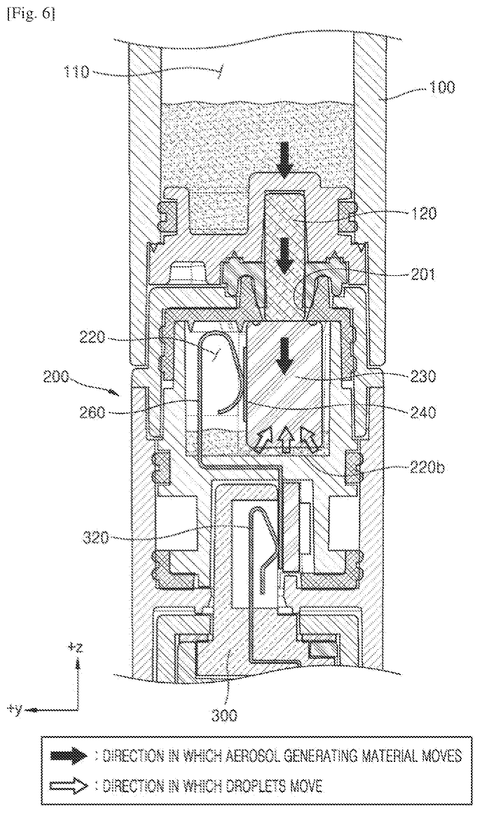

At least the portion of the wick 230 adjacent to the bottom surface 220b of the chamber 220 may absorb the liquefied aerosol accumulated on the bottom surface 220b, thereby preventing accumulation of the liquefied aerosol in the chamber 220. Hereinafter, a process in which at least a portion of the wick 230 absorbs the liquefied aerosol accumulated in the chamber 220 will be described in detail with reference to FIG. 6.

FIG. 6 is a diagram of a process in which the aerosol liquefied in the chamber of the aerosol generating device according to an embodiment is absorbed into the wick. FIG. 6 is a cross-sectional view of the aerosol generating device 10 shown in FIG. 1, taken along the y-z plane. In FIG. 6, the black arrows indicate a direction in which the aerosol generating material moves, and white arrows indicate a direction in which the liquefied aerosol or droplet moves.

Referring to FIG. 6, the aerosol generating device 10 according to an embodiment may include the cartridge 100, the heater assembly 200, and the body 300. At least one of the components of the aerosol generating device 10 may be identical or similar to the components of the aerosol generating device 10 shown in FIG. 1 or 2, and hereinafter, descriptions thereof will not be repeatedly given.

The cartridge 100 may include a reservoir 110 in which the aerosol generating material is stored, and the aerosol generating material stored in the reservoir 110 may move, due to a gravity, from the reservoir 110 toward the aerosol generating material inlet 201 of the heater assembly 200. For example, although not shown, a discharge hole (not shown) may be formed in a region of the reservoir 110 (e.g., a region in the −z direction) toward the heater assembly 200, and the aerosol generating material stored in the reservoir 110 may move, through the discharge hole, in a direction toward the aerosol generating material inlet 201 of the heater assembly 200.

According to an embodiment, the aerosol generating material may be introduced into the chamber 220 of the heater assembly 200 through the aerosol generating material inlet 201, and may be absorbed into the wick 230 arranged adjacent to the aerosol generating material inlet 201.

According to an embodiment, the cartridge 100 may further include a liquid delivery element 120 configured to deliver the aerosol generating material, which is stored in the reservoir 110, to the wick 230 of the heater assembly 200.

The liquid delivery element 120 may be in the aerosol generating material inlet 201, an end of the liquid delivery element 120 may be adjacent to the discharge hole of the reservoir 110, and another end of the liquid delivery element 120 may contact the wick 230 in the chamber 220. The liquid delivery element 120 may absorb the aerosol generating material stored in the reservoir 110 through the aforementioned arrangement structure and then deliver the absorbed aerosol generating material to the wick 230, and the wick 230 may absorb the aerosol generating material delivered by the liquid delivery element 120.

For example, the liquid delivery element 120 may include cotton to absorb the aerosol generating material stored in the reservoir 110, but the material of the liquid delivery element 120 is not limited thereto. In another example, the liquid delivery element 120 may also include ceramic, glass, or porous ceramic capable of absorbing the aerosol generating material.

The heater 240 may be on the side surface (e.g., the side surface 233 shown in FIG. 5) of the wick 230, and may heat the aerosol generating material absorbed into the wick 230 as the power is supplied from the battery (not shown) of the body 300.

According to an embodiment, the heater 240 may be electrically connected to the battery in the body 300 through a first electrical connection member 260 of the heater assembly 200 and a second electrical connection member 320 of the body 300.

For example, a first region of the first electrical connection member 260 may contact at least a region of the heater 240, and a second region of the first electrical connection member 260 may be exposed to an insertion groove (e.g., the insertion groove 200h shown in FIG. 5), through which a portion of the body 300 is inserted into the heater assembly 200. As such, the second region of the first electrical connection member 260 may contact the second electrical connection member 320. In addition, a first region of the second electrical connection member 320 may connect the second region of the first electrical connection member 260, and a second region of the second electrical connection member 320 may contact the battery in the body 300.

For example, the first electrical connection member 260 and/or the second electrical connection member 320 may include a conductive material having elasticity, but is/are not limited thereto. As another embodiment, the first electrical connection member 260 and/or the second electrical connection member 320 may also include a cable or a flexible printed circuit board.

An electrical path may be formed between the heater 240 and the battery by the first electrical connection member 260 and the second electrical connection member 320, and power may be supplied from the battery to the heater 240 through the aforementioned electrical path.

As the heater 240 is on the side surface of the wick 230, the vapor generated as the aerosol generating material is heated may be generated in a region of the chamber 220 adjacent to the side surface of the chamber 230. The vapor may be mixed with the external air introduced into the chamber 220 through the air inlet (e.g., the air inlet 202 shown in FIG. 3 or 4), and as a result, the aerosol may be generated in the region of the chamber 220 adjacent to the side surface of the wick 230.

At least some of the aerosol generated in the chamber 220 may be cooled and liquefied due to contact with the external air introduced into the chamber 220, and the liquefied aerosol (or ‘droplet’) may fall onto the bottom surface 220b of the chamber 220 and be accumulated or piled on the bottom surface 220b of the chamber 220.

When an amount or more of liquefied aerosol is accumulated in the chamber 220, the liquefied aerosol may leak from the chamber 220 and cause malfunction or damage of the components of the aerosol generating device 10. Also, a portion of the heater 240 may be submerged under the liquefied aerosol, which degrades the heating efficiency of the heater 240.

In the heater assembly 200 according to an embodiment, at least a portion of the wick 230 adjacent to the bottom surface 220b of the chamber 220 may absorb the liquefied aerosol accumulated on the bottom surface 220b of the chamber 220. In the aerosol generating device 10 according to an embodiment, the wick 230 is arranged to absorb the liquefied aerosol, and therefore, the liquefied aerosol may be not accumulated in the chamber 220. As a result, the aerosol generating device 10 according to an embodiment may prevent the liquefied aerosol from causing malfunction or damage of the components of the aerosol generating device 10 or degradation of the heating efficiency of the heater 240 due to submerging under the liquefied aerosol.

In addition, the liquefied aerosol absorbed into the wick 230 may be heated again by the heater 240 and transformed into the aerosol. Accordingly, the aerosol generating device 10 according to an embodiment may prevent accumulation of the liquefied aerosol in the chamber 220, and at the same time, may improve a generation amount of aerosol (or ‘an amount of atomization’) by heating again the liquefied aerosol.

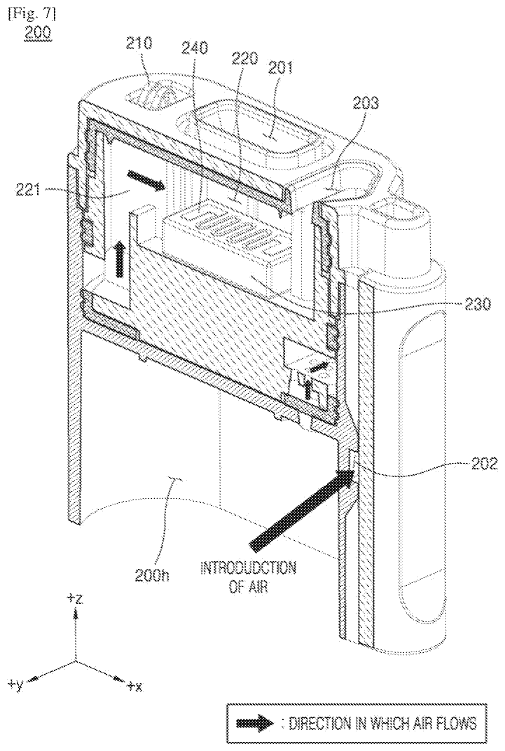

FIG. 7 is a perspective view of a cross-section of the heater assembly shown in FIG. 3, taken in the A-A′ direction, according to another embodiment. In FIG. 7, block arrows indicate a direction in which the air (or ‘the external air’) moves.

Referring to FIG. 7, the heater assembly 200 according to this embodiment may include the aerosol generating material inlet 201, the air inlet 202, the air outlet 203, the first combination member 210, the chamber 220, the wick 230, the heater assembly 200, and the air flow path (not shown). The heater assembly 200 according to this embodiment may include a heater assembly which is obtained by only modifying the arrangement structure of the wick 230 and the heater assembly 200 of the heater assembly 200 shown in FIG. 4. Thus, the repetitive descriptions will be omitted.

The wick 230 may be in a region in the chamber 220 adjacent to the aerosol generating material inlet 201, and may absorb the aerosol generating material introduced from the reservoir 110 (e.g., the reservoir 110 shown in FIG. 2) of the cartridge 100 (e.g., the cartridge 100 shown in FIG. 1 or 2) into the chamber 220 through the aerosol generating material inlet 201.

The heater assembly 200 according to an embodiment may further include a support member 221 arranged in the chamber 220. The support member 221 may be arranged in the chamber 220 and may fix a position of the wick 230 in the chamber 220. As the wick 230 is fixed to the inside of the chamber 220 by the support member 221, the aerosol generating material may be stably absorbed in the process of using the aerosol generating device. For example, when inclination or wavering occurs in the process of using the aerosol generating device, the position of the wick 230 is fixed by the support member 221, and thus, the aerosol generating material introduced into the chamber 220 may be stably absorbed.

The heater 240 may be arranged in at least one region of the top surface (e.g., the surface in the +z direction) of the wick 230 facing the aerosol generating material inlet 201 and heat the aerosol generating material absorbed into the wick 230. For example, the heater 240 may be electrically connected to the battery (not shown) in the body (e.g., the body 300 shown in FIG. 1 or 2) inserted into the insertion groove 200h, and may generate heat by the power supplied from the battery to heat the aerosol generating material absorbed into the wick 230.

According to an embodiment, the heater 240 may include a conductive pattern printed or insert-injected on the top surface of the wick 230, but is not limited thereto. In another example, the heater 240 may also include a conductive plate (not shown) on the top surface of the wick 230.

As the heater 240 is arranged on the top surface of the wick 230, vapor may be generated due to heating of the aerosol generating material in a region of the chamber 220 adjacent to the top surface of the wick 230. The vapor generated from the aerosol generating material may be mixed with the air introduced into the chamber 220 through the air inlet 202.

For example, the external air introduced into the heater assembly 200 through the air inlet 202 may flow along the air flow path 250 into the chamber 220. The air flow path 250 may connect the air inlet 202 and the air outlet 203 and form a flow path through which the external air and/or aerosol moves.

According to an embodiment, at least a part of the air flow path 250 may extend in the heater assembly 200 along an edge of the heater assembly 200, and the external air introduced to the inside of the heater assembly 200 through the air inlet 202 may reach the inside of the chamber 220 along the air flow path 250.

The vapor generated as the aerosol generating material is heated by the heater 240 may be mixed with the external air introduced into the chamber 220 through the air flow path 250, and as a result, the aerosol may be generated in the region of the chamber 220 adjacent to the top surface of the wick 230. The aerosol and/or external air may be discharged to the outside of the heater assembly 200 through the air outlet 203, and the user may inhale the aerosol discharged outside.

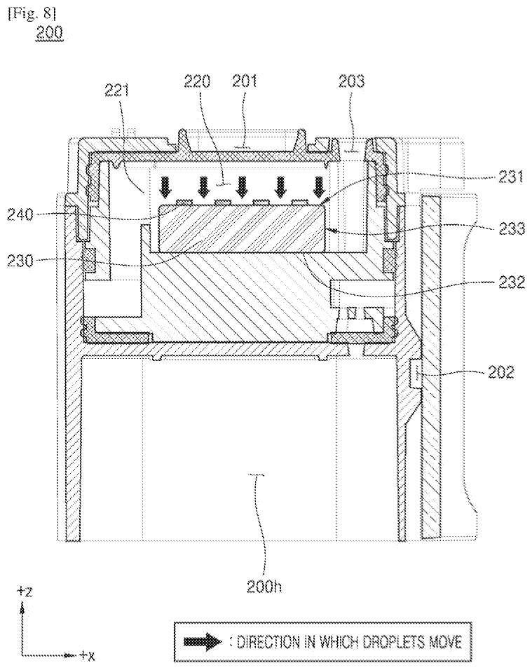

FIG. 8 is a cross-sectional view of the heater assembly shown in FIG. 7. In FIG. 8, the black arrows indicate a direction in which the liquefied aerosol (or ‘droplet’) moves.

Referring to FIG. 8, the heater assembly 200 according to an embodiment may include the chamber 220, the support member 221, the wick 230 and the heater 240. The heater assembly 200 according to this embodiment may be substantially identical or similar to the heater assembly 200 shown in FIG. 7. Thus, repetitive descriptions will be omitted.

The wick 230 absorbing the aerosol generating material provided from the cartridge (e.g., the cartridge 100 shown in FIG. 2) and the heater 240 configured to heat the aerosol generating material absorbed into the wick 230 may be arranged in the chamber 220 of the heater assembly 200.

At least a region of the wick 230 may be arranged to face the aerosol generating material inlet 201 and absorb the aerosol generating material introduced into the chamber 220 through the aerosol generating material inlet 201. The position of the wick 230 is fixed to the inside of the chamber 220 by the support member 221, and the aerosol generating material may be stably absorbed even when the heater assembly 200 wavers or inclines.

According to an embodiment, the wick 230 may include the first surface 231 (or ‘the top surface’) facing the aerosol generating material inlet 201, the second surface 232 (or ‘the bottom surface’) in an opposite position of the first surface 231, and the side surface 233 surrounding the space between the first surface 231 and the second surface 232.

When the heater assembly 200 and the cartridge are coupled to each other, the first surface 231 of the wick 230 may be arranged to face the reservoir of the cartridge, and may absorb the aerosol generating material introduced from the reservoir into the chamber 220 through the aerosol generating material inlet 201.

The second surface 232 of the wick 230 may be in the opposite position of the first surface 231 and arranged to face the bottom surface 220b of the chamber 220. Although the drawing only illustrates an embodiment in which the second surface 232 of the wick 230 contacts the bottom surface 220b of the chamber 220, according to an embodiment, the second surface 232 of the wick 230 may be arranged apart in a certain distance from the bottom surface 220b of the chamber 220.

The side surface 233 of the wick 230 may be arranged to surround the space between the first surface 231 and the second surface 232.

The heater 240 may be arranged on the first surface 231 of the wick 230 to heat the aerosol generating material absorbed into the wick 230. For example, when the heater assembly 200 and the body (e.g., the body 300 shown in FIG. 1 or 2) are coupled to each other, the heater 240 may be electrically connected to a battery (not shown) of the body through an electrical connection member (e.g., the first electrical connection member 260 shown in FIG. 5), and may generate heat to heat the aerosol generating material as the power is supplied from the battery.

As the heater 240 is on the first surface 231 of the wick 230, the vapor generated as the aerosol generating material is heated may be generated in a region of the chamber 220 (e.g., a region apart from the first direction 231 in the +z direction) adjacent to the first surface 231 of the wick 230. The vapor may be mixed with the external air introduced into the heater assembly 200, and as a result, the aerosol may be generated in a region of the chamber 220 adjacent to the first surface 231 of the wick 230.

At least some of the aerosol generated in the chamber 220 may be cooled and liquefied by contact with the external air introduced into the chamber 220. When the liquefied aerosol (or ‘droplet’) is accumulated in the chamber 220, malfunction or damage of the components of the aerosol generating device may be caused, and the heating efficiency of the heater 240 may be degraded.

For example, when the liquefied aerosol is accumulated in the chamber 220, the liquefied aerosol may leak from the chamber 220 and cause malfunction or damage of the components of the heater assembly 200. Also, if a portion of the heater 240 may be submerged under the liquefied aerosol, the heating efficiency of the heater 240 may be degraded.

In the heater assembly 200 according to an embodiment, the heater 240 is arranged on the first surface 231 of the wick 230, and the aerosol may be generated above the wick 230 (e.g., in a region in the +z direction from the wick 230). As a result, even when some of the aerosol is liquefied, the liquefied aerosol may fall onto the wick 230 and be absorbed again into the wick 230.

That is, in the heater assembly 200 according to this embodiment, through the arrangement structure of the wick 230 and the heater 240, the liquefied aerosol is absorbed again into the chamber 230 instead of being accumulated in the chamber 220. As such, the malfunction or damage of the components of the aerosol generating device due to leakage of the liquefied aerosol and degradation in the heating efficiency due to submerging of the heater 240 may be prevented.

In addition, the liquefied aerosol absorbed into the wick 230 may be heated again by the heater 230 and transformed into the aerosol. Therefore, the heater assembly 200 according to this embodiment not only prevents accumulation of the liquefied aerosol in the chamber 220, but also improves the production amount of the aerosol.

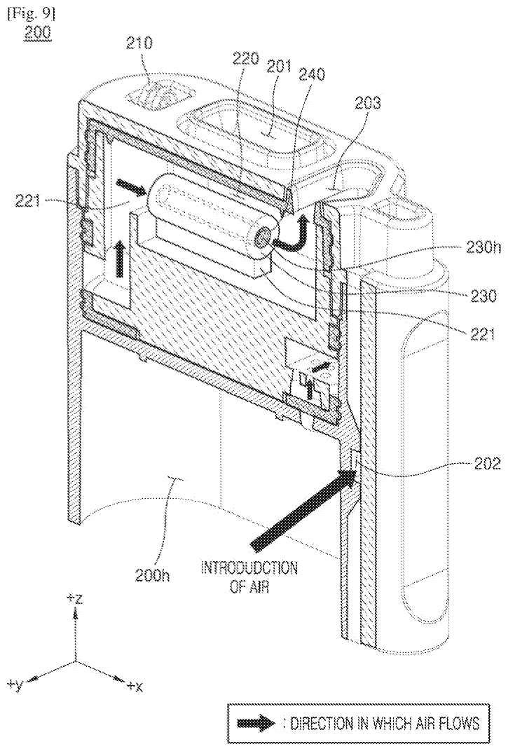

FIG. 9 is a perspective view of a cross-section of the heater assembly shown in FIG. 3, taken in the A-A′ direction, according to another embodiment. In FIG. 9, black arrows indicate a direction in which the air (or ‘the external air’) moves.

Referring to FIG. 9, the heater assembly 200 according to an embodiment may include the aerosol generating material inlet 201, the air inlet 202, the air outlet 203, the first combination member 210, the chamber 220, the wick 230, the heater 240, and the air flow path (not shown). The heater assembly 200 according to this embodiment may include a heater assembly which is obtained by only modifying the form and arrangement structure of the wick 230 and the heater 240 of the heater assembly 200 shown in FIG. 4. Thus, repetitive descriptions will be omitted.

The wick 230 may be in the chamber 230, and may absorb the aerosol generating material introduced from the reservoir (e.g., the reservoir 110 shown in FIG. 2) of the cartridge (e.g., the cartridge 100 shown in FIG. 1 or 2) into the chamber 220 through the aerosol generating material inlet 201.

The heater assembly 200 according to an embodiment may further include a support member 221 arranged in the chamber 220. The support member 221 may be arranged in the chamber 220 and may fix a position of the wick 230 in the chamber 220. As the wick 230 is fixed to the inside of the chamber 220 by the support member 221, the aerosol generating material may be stably absorbed in the process of using the aerosol generating device. For example, when inclination or wavering occurs in the process of using the aerosol generating device, the position of the wick 230 is fixed by the support member 221, and thus, the aerosol generating material introduced into the chamber 220 may be stably absorbed.

The wick 230 may include a through hole 230h penetrating the wick 230. For example, the through hole 230h may be formed in a longitudinal direction (e.g., the −x-axis direction) of the wick 230 (or a longitudinal direction of the chamber 220), but is not limited thereto.

The heater 240 may be arranged in the through hole 230h of the wick 230 to heat the aerosol generating material absorbed into the wick 230. For example, the heater 240 may be in an inner side surface of the through hole 230h, and as the power is supplied, the heater 240 may generate heat to heat the aerosol generating material absorbed into the wick 230.

According to an embodiment, the heater 240 may be electrically connected to a battery (not shown) in the body (e.g., the body 300 shown in FIG. 1 or 2) inserted into the insertion groove 200h of the heater assembly 200, and may generate heat in response to the power supplied from the battery to heat the aerosol generating material absorbed into the wick 230.

According to an embodiment, the heater 240 may include a conductive patter printed or insert-injected on the inner side surface of the through hole 230h of the wick 230, but the embodiment is not limited thereto. In another embodiment, the heater 240 may also include a conductive plate arranged on the inner side surface of the groove hole 230h of the wick 230.

As the heater 240 is on the inner side surface of the through hole 230h of the wick 230, vapor may be generated by heating the aerosol generating material in the through hole 230h. The vapor generated from the aerosol generating material may be mixed with the air introduced into the chamber 220 through the air inlet 202.

For example, the external air introduced into the heater assembly 200 through the air inlet 202 may flow along the air flow path 250 to move into the chamber 220. The air flow path 250 may connect the air inlet 202 and the air outlet 203 and form the flow path through which the external air and/or aerosol moves.

According to an embodiment, at least a part of the air flow path 250 may extend in the heater assembly 200 along an edge of the heater assembly 200, and the external air introduced into the heater assembly 200 through the air inlet 202 may reach the inside of the chamber 220 along the air flow path 250.

As the aerosol generating material is heated by the heater 240, the vapor that has been generated may be mixed with the external air introduced into the chamber 220 and moved into the through hole 230h. As a result, the aerosol may be generated in the through hole 230h of the wick 230. The aerosol generated in the through hole 230h of the wick 230 or the external air introduced into the chamber 220 may be at least partially discharged to the outside of the heater assembly 200 through the air outlet 203, and the user may inhale the aerosol that has been discharged.

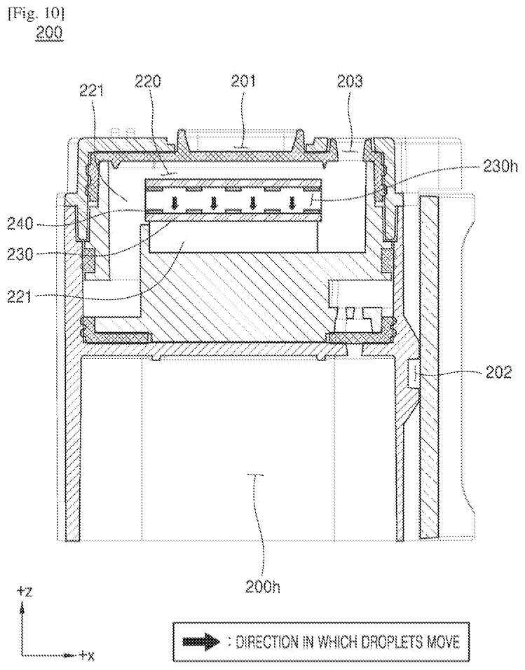

FIG. 10 is a cross-sectional view of the heater assembly shown in FIG. 9. In FIG. 0.10, black arrows indicate a direction in which the liquefied aerosol (or ‘droplet’) moves.

Referring to FIG. 10, the heater assembly 200 according to an embodiment may include the chamber 220, the support member 221, the wick 230, and the heater 240. The heater assembly 200 according to this embodiment may be substantially identical or similar to the heater assembly 200 shown in FIG. 9, and thus repetitive descriptions will be omitted.

The wick 230 absorbing the aerosol generating material provided from the cartridge (e.g., the cartridge 100 shown in FIG. 1 or 2) and the heater 240 configured to generate the aerosol generating material absorbed into the wick 230 may be arranged in the chamber 220 of the heater assembly 200.

At least a region of the wick 230 may be arranged to face the aerosol generating material inlet 201 and absorb the aerosol generating material introduced into the chamber 220 through the aerosol generating material inlet 201. The position of the wick 230 is fixed to the inside of the chamber 220 by the support member 221, and the aerosol generating material may be stably absorbed even when the heater assembly 200 wavers or inclines.

The wick 230 may include the through hole 230h generated in a direction in which the wick 230 extends (e.g., the −x-axis direction), and the heater 240 may be arranged in the through hole 230h.

The heater 240 may contact at least one region of the wick 230 through the aforementioned arrangement structure, and as power is supplied, the heater 240 may heat the aerosol generating material absorbed into the wick 230. For example, when the heater assembly 200 and the body (e.g., the body 300 shown in FIG. 1 or 2) are coupled to each other, the heater 240 may be electrically connected to a battery (not shown) of the body, and may generate heat to heat the aerosol generating material as the power is supplied from the battery.

As the heater 240 is on the inner side surface of the through hole 230h of the wick 230, vapor may be generated by heating the aerosol generating material in the through hole 230h. The vapor generated from the aerosol generating material may be mixed with the air in the through hole 230h, and as a result thereof, the aerosol may be generated in the through hole 230h of the wick 230.

In this case, at least some of the aerosol generated in the through hole 230h may be cooled due to contact with the air in the through hole 230h, and as a result, at least some of the aerosol may be liquefied.

When the liquefied aerosol is accumulated in the chamber 220, the leakage of the liquefied aerosol may cause malfunction or damage of the aerosol generating device. Also, a portion of the heater 240 may be submerged under the liquefied aerosol, which degrades the heating efficiency of the heater 240.

In the heater assembly 200 according to an embodiment, the wick 230 surrounds an outer circumferential surface of the heater 240, the aerosol liquefied in the through hole 230h may be not accumulated in the chamber 230 and may be absorbed again into the wick 230. For example, the wick 230 may absorb the liquefied aerosol descending in the through hole 230h, thereby preventing the liquefied aerosol from being accumulated in the chamber 220.

Accordingly, the heater assembly 200 according to this embodiment may prevent the leakage of the liquefied aerosol from causing malfunction or damage of the components of the aerosol generating device, and it also prevents the degradation of the heating efficiency which may be caused as the heater 240 is submerged.

In addition, the liquefied aerosol absorbed into the wick 230 may be heated again by the heater 230 and transformed into the aerosol. Therefore, the heater assembly 200 according to this embodiment may prevent the liquefied aerosol from being accumulated in the chamber 220, and at the same time, may improve the generation amount of the aerosol.

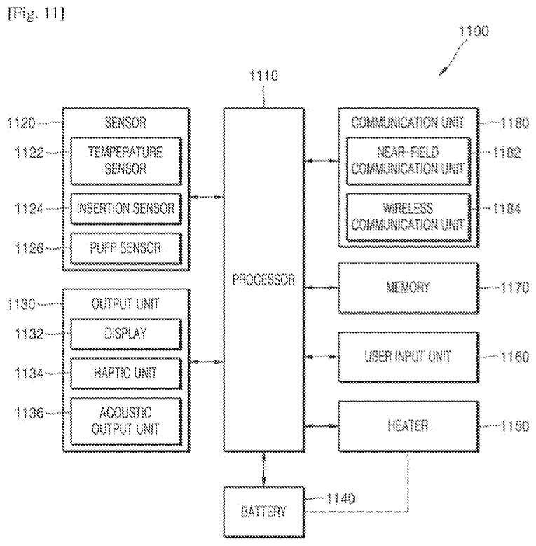

FIG. 11 is a block diagram of an aerosol generating device according to an embodiment.

The aerosol generating device 1100 may include a controller 1110, a sensing unit 1120, an output unit 1130, a battery 1140, a heater 1150, a user input unit 1160, a memory 1170, and a communication unit 1180. However, the internal structure of the aerosol generating device 1100 is not limited to those illustrated in FIG. 11. That is, according to the design of the aerosol generating device 1100, it will be understood by one of ordinary skill in the art that some of the components shown in FIG. 11 may be omitted or new components may be added.

The sensing unit 1120 may sense a state of the aerosol generating device 1100 and a state around the aerosol generating device 1100, and transmit sensed information to the controller 1110. Based on the sensed information, the controller 1110 may control the aerosol generating device 1100 to perform various functions, such as controlling an operation of the heater 1150, limiting smoking, determining whether an aerosol generating article (e.g., a cigarette, a cartridge, or the like) is inserted, displaying a notification, or the like.

The sensing unit 1120 may include at least one of a temperature sensor 1122, an insertion detection sensor, and a puff sensor 1126, but is not limited thereto.

The temperature sensor 1122 may sense a temperature at which the heater 1150 (or an aerosol generating material) is heated. The aerosol generating device 1100 may include a separate temperature sensor for sensing the temperature of the heater 1150, or the heater 1150 may serve as a temperature sensor. Alternatively, the temperature sensor 1122 may also be arranged around the battery 1140 to monitor the temperature of the battery 1140.

The insertion detection sensor 1124 may sense insertion and/or removal of an aerosol generating article. For example, the insertion detection sensor 1124 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 1126 may sense a user's puff on the basis of various physical changes in an airflow passage or an airflow channel. For example, the puff sensor 1126 may sense a user's puff on the basis of any one of a temperature change, a flow change, a voltage change, and a pressure change.

The sensing unit 1120 may include, in addition to the temperature sensor 1122, the insertion detection sensor 1124, and the puff sensor 1126 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 1130 may output information on a state of the aerosol generating device 1100 and provide the information to a user. The output unit 1130 may include at least one of a display unit 1132, a haptic unit 1134, and a sound output unit 1136, but is not limited thereto. When the display unit 1132 and a touch pad form a layered structure to form a touch screen, the display unit 1132 may also be used as an input device in addition to an output device.

The display unit 1132 may visually provide information about the aerosol generating device 1100 to the user. For example, information about the aerosol generating device 1100 may mean various pieces of information, such as a charging/discharging state of the battery 1140 of the aerosol generating device 1100, a preheating state of the heater 1150, an insertion/removal state of an aerosol generating article, or a state in which the use of the aerosol generating device 1100 is restricted (e.g., sensing of an abnormal object), or the like, and the display unit 1132 may output the information to the outside. The display unit 1132 may be, for example, a liquid crystal display panel (LCD), an organic light-emitting diode (OLED) display panel, or the like. In addition, the display unit 1132 may be in the form of a light-emitting diode (LED) light-emitting device.

The haptic unit 1134 may tactilely provide information about the aerosol generating device 1100 to the user by converting an electrical signal into a mechanical stimulus or an electrical stimulus. For example, the haptic unit 1134 may include a motor, a piezoelectric element, or an electrical stimulation device.

The sound output unit 1136 may audibly provide information about the aerosol generating device 1100 to the user. For example, the sound output unit 1136 may convert an electrical signal into a sound signal and output the same to the outside.

The battery 1140 may supply power used to operate the aerosol generating device 1100. The battery 1140 may supply power such that the heater 1150 may be heated. In addition, the battery 1140 may supply power required for operations of other components (e.g., the sensing unit 1120, the output unit 1130, the user input unit 1160, the memory 1170, and the communication unit 1180) in the aerosol generating device 1100. The battery 1140 may be a rechargeable battery or a disposable battery. For example, the battery 1140 may be a lithium polymer (LiPoly) battery, but is not limited thereto.

The heater 1150 may receive power from the battery 1140 to heat an aerosol generating material. Although not illustrated in FIG. 11, the aerosol generating device 1100 may further include a power conversion circuit (e.g., a direct current (DC)/DC converter) that converts power of the battery 1140 and supplies the same to the heater 1150. In addition, when the aerosol generating device 1100 generates aerosols in an induction heating method, the aerosol generating device 1100 may further include a DC/alternating current (AC) that converts DC power of the battery 1140 into AC power.

The controller 1110, the sensing unit 1120, the output unit 1130, the user input unit 1160, the memory 1170, and the communication unit 1180 may each receive power from the battery 1140 to perform a function. Although not illustrated in FIG. 11, the aerosol generating device 1100 may further include a power conversion circuit that converts power of the battery 1140 to supply the power to respective components, for example, a low dropout (LDO) circuit, or a voltage regulator circuit.

In an embodiment, the heater 1150 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1150 may be implemented by a metal wire, a metal plate on which an electrically conductive track is arranged, a ceramic heating element, or the like, but is not limited thereto.

In another embodiment, the heater 1150 may be a heater of an induction heating type. For example, the heater 1150 may include a susceptor that heats an aerosol generating material by generating heat through a magnetic field applied by a coil.

The user input unit 1160 may receive information input from the user or may output information to the user. For example, the user input unit 1160 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 11, the aerosol generating device 1100 may further include a connection interface, such as a universal serial bus (USB) interface, and may connect to other external devices through the connection interface, such as the USB interface, to transmit and receive information, or to charge the battery 1140.

The memory 1170 is a hardware component that stores various types of data processed in the aerosol generating device 1100, and may store data processed and data to be processed by the controller 1110. The memory 1170 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1170 may store an operation time of the aerosol generating device 1100, the maximum number of puffs, the current number of puffs, at least one temperature profile, data on a user's smoking pattern, etc.

The communication unit 1180 may include at least one component for communication with another electronic device. For example, the communication unit 1180 may include a short-range wireless communication unit 1182 and a wireless communication unit 1184.

The short-range wireless communication unit 1182 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 1184 may include a cellular network communication unit, an Internet communication unit, a computer network (e.g., local area network (LAN) or wide area network (WAN)) communication unit, or the like, but is not limited thereto. The wireless communication unit 1184 may also identify and authenticate the aerosol generating device 1100 within a communication network by using subscriber information (e.g., International Mobile Subscriber Identifier (IMSI)).

The controller 1110 may control general operations of the aerosol generating device 1100. In an embodiment, the controller 1110 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 1110 may control the temperature of the heater 1150 by controlling supply of power of the battery 1140 to the heater 1150. For example, the controller 1110 may control power supply by controlling switching of a switching element between the battery 1140 and the heater 1150. In another example, a direct heating circuit may also control power supply to the heater 1150 according to a control command of the controller 1110.

The controller 1110 may analyze a result sensed by the sensing unit 1120 and control subsequent processes to be performed. For example, the controller 1110 may control power supplied to the heater 1150 to start or end an operation of the heater 1150 on the basis of a result sensed by the sensing unit 1120. As another example, the controller 1110 may control, based on a result sensed by the sensing unit 1120, an amount of power supplied to the heater 1150 and the time the power is supplied, such that the heater 1150 may be heated to a certain temperature or maintained at an appropriate temperature.

The controller 1110 may control the output unit 1130 on the basis of a result sensed by the sensing unit 1120. For example, when the number of puffs counted through the puff sensor 1126 reaches a preset number, the controller 1110 may notify the user that the aerosol generating device 1100 will soon be terminated through at least one of the display unit 1132, the haptic unit 1134, and the sound output unit 1136.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol generating device comprising:
a cartridge comprising a reservoir for storing an aerosol generating material;
a heater assembly detachably coupled to the cartridge and configured to heat the aerosol generating material provided from the cartridge to generate an aerosol; and
a body detachably coupled to the heater assembly and comprising a battery configured to supply power to the heater assembly,
wherein the heater assembly comprises:
a chamber in fluid communication with the reservoir of the cartridge;
a wick arranged in the chamber, configured to absorb the aerosol generating material provided from the reservoir, and comprising a first surface facing the reservoir, a second surface arranged in an opposite position of the first surface to face a bottom surface of the chamber, and a side surface surrounding a space between the first surface and the second surface; and
a heater arranged on the side surface of the wick and configured to heat the aerosol generating material absorbed into the wick.

2. The aerosol generating device of claim 1,
wherein a region of the wick adjacent to the bottom surface of the chamber absorbs a liquefied aerosol accumulated in the chamber.

3. The aerosol generating device of claim 1,
wherein the second surface of the wick is arranged apart by a certain distance from the bottom surface of the chamber.

4. The aerosol generating device of claim 1,
wherein the heater assembly further comprises a support member for supporting the wick in the chamber.

5. The aerosol generating device of claim 1,
wherein the heater assembly further comprises an aerosol generating material inlet arranged in a region facing the cartridge, and
the aerosol generating material stored in the reservoir is introduced into the chamber through the aerosol generating material inlet and then absorbed into the wick.

6. The aerosol generating device of claim 1,
wherein the heater assembly comprises:
an air inlet configured to introduce external air into the heater assembly;
an air outlet configured to discharge the aerosol generated in the chamber to outside of the heater assembly; and
an air flow path connecting the air inlet to the air outlet.

7. The aerosol generating device of claim 6,
wherein at least a portion of the air flow path extends in the heater assembly along an edge of the heater assembly.

8. The aerosol generating device of claim 1,
wherein the heater assembly further comprises an electrical connection member electrically connecting the heater to the battery in the body.

9. The aerosol generating device of claim 1,
wherein the wick comprises ceramic.

10. The aerosol generating device of claim 1,
wherein the cartridge further comprises a liquid delivery element configured to deliver the aerosol generating material stored in the reservoir to the wick of the heater assembly.

11. The aerosol generating device of claim 10,
wherein the liquid delivery element comprises cotton for absorbing the aerosol generating device.

12. The aerosol generating device of claim 1,
wherein the heater comprises a conductive pattern that is printed on a side surface of the wick, and
the conductive pattern, as power is supplied from the battery, heats the aerosol generating material absorbed into the wick.

13. The aerosol generating device of claim 1,
wherein the heater comprises a conductive pattern that is insert-injected on the side surface of the wick, and
the conductive pattern, as power is supplied from the battery, heats the aerosol generating material absorbed into the wick.

14. An aerosol generating device comprising:
a cartridge comprising a reservoir for storing an aerosol generating material;
a heater assembly detachably coupled to the cartridge and configured to heat the aerosol generating material provided from the cartridge to generate an aerosol; and
a body detachably coupled to the heater assembly and comprising a battery configured to supply power to the heater assembly,
wherein the heater assembly comprises:
a chamber in fluid communication with the reservoir of the cartridge;
a wick arranged in the chamber, configured to absorb the aerosol generating material provided from the reservoir, and comprising a first surface facing the reservoir, a second surface arranged in an opposite position of the first surface to face a bottom surface of the chamber, and a side surface surrounding a space between the first surface and the second surface; and
a heater arranged on the first surface of the wick and configured to heat the aerosol generating material absorbed into the wick, and
wherein the first surface of the wick absorbs the aerosol liquefied in the chamber.

15. An aerosol generating device comprising:
a cartridge comprising a reservoir for storing an aerosol generating material;
a heater assembly detachably coupled to the cartridge and configured to heat the aerosol generating material provided from the cartridge to generate an aerosol; and
a body detachably coupled to the heater assembly and comprising a battery configured to supply power to the heater assembly, wherein the heater assembly comprises:
a chamber in fluid communication with the reservoir of the cartridge;
a wick arranged in the chamber, configured to absorb the aerosol generating material provided from the reservoir, and comprising a through hole extending in a longitudinal direction of the chamber; and
a heater arranged in the through hole of the wick and configured to heat the aerosol generating material absorbed into the wick, and
wherein at least a region of the wick absorbs the aerosol liquefied in the chamber.
